(19) United States
(12) Patent Application Publication
(10) Pub. No.: US 2024/0370816 A1
(43) Pub. Date: Nov. 7, 2024

(54) LOGISTICS COMMUNICATION SYSTEMS AND METHODS FOR RECOMMENDING DRIVERS IN A LOGISTICS ENVIRONMENT

(71) Applicant: Covenant Trucking, LLC, Midland, TX (US)

(72) Inventor: Connor Johnson, Midland, TX (US)

(73) Assignee: Covenant Trucking, LLC, Midland, TX (US)

(21) Appl. No.: 18/142,580

(22) Filed: May 2, 2023

(51) Int. Cl. G06Q 10/0835; G06Q 10/0631

(52) U.S. Cl. CPC G06Q 10/0835; G06Q 10/063114

(57) ABSTRACT

The present invention relates to a logistics communication system and a method for recommending a driver in a logistics environment. The method includes receiving at least one query from a user to find a driver from a plurality of drivers. Further, the method includes determining at least one event and at least one parameter to select the driver from the plurality of drivers based on the at least one query. Further, the method includes determining the driver from the plurality of drivers based on the at least one event and the at least one parameter. Further, the method includes recommending the determined driver from the plurality of drivers to the user/customer.

### TECHNICAL FIELD

The present invention generally relates to logistics communications platforms, and more specifically relates to logistics communication systems and methods for recommending a driver.

### Problem Statement and History

### Interpretation Considerations

This section describes technical field in detail and discusses problems encountered in the technical field. Therefore, statements in the section are not to be construed as prior art.

### Discussion of History of the Problem

Logistics industry is a large industry comprising complex communications channels among users (e.g., shippers, carriers, freight forwarders, traders, or the like). Currently, the logistics industry does not have any methods or techniques for finding a suitable driver based on needs of the users. Further, there is a need of micro-level customization of communication flow among all the users and more transparent understanding of communication to find the driver in order to optimize the flow operations in the logistics industry. There is presently no solution to these drawbacks. Accordingly, the present invention provides such a solution.

### SUMMARY

The above objective is achieved by logistics communication systems and methods as defined in the claims.

A logistics communication system and method for recommending a driver in a logistics environment is disclosed. One method includes receiving at least one query from a user to find a driver from a plurality of drivers. A user includes at least one of a customer, a carrier, or a load dispatcher. Further, the method includes determining at least one event and at least one parameter to select the driver from the plurality of drivers based on the at least one query. An event includes a ready for dispatch event, an accepted event, a loaded event, a delivered event, a paused event, a delayed event, or a cancelled event. Further, the method includes determining the driver from the plurality of drivers based on the at least one event and the at least one parameter. The at least one parameter includes a driver profile, owner operator, a carrier identifier, a unit identifier, on-duty time, off-duty time, a name of the driver, a driver license number, a tax identifier number, date of birth of the driver, locked-out time, locking time, and/or shift time. Further, the method includes recommending the a driver from the plurality of drivers to the user.

In an embodiment of the present invention, the driver from the plurality of drivers is selected by changing a load state to dispatched, filtering the at least one driver from the plurality of drivers by the carrier, filtering an off-duty driver from the plurality of drivers, filtering a busy driver from the plurality of drivers, filtering a notified driver from the plurality of drivers, and/or sorting the driver from the plurality of drivers based on waiting time for a load.

In another embodiment of the present invention, the driver from the plurality of drivers is selected by determining that at least one load is dispatched, determining that the at least one driver is not available, selecting at least one carrier for dispatching the at least one load using a load job identifier, selecting the at least one driver from the plurality of drivers, sorting the at least one driver from the plurality of drivers based on a last load accepted time, and notifying at least one sorted driver from the plurality of drivers, wherein a location of the at least one sorted driver is closed to a location of the user. Alternatively, the at least one selected driver may be on-duty, wherein the at least one driver is selected based on a load status completed event and a load status cancelled event.

In another embodiment of the present invention, the driver from the plurality of drivers is determined by selecting at least one carrier for dispatching the at least one load using a load job identifier, determining that the driver is new, and notifying the new driver for dispatching the at least one load by prioritizing the new driver from the plurality of drivers.

In another embodiment of the invention, the driver from the plurality of drivers is selected by checking in a mine list, obtaining a latitude and a longitude using a World Geodetic System (WGS) upon checking in the mine list, determining that the load is accepted, determining that the driver is close to the user, and/or changing a load state to loaded or delivered.

In another embodiment of the present invention, the driver from the plurality of drivers is selected by receiving a request notification for at least one load, determining whether the at least one load is accepted, and performing one of: setting a load dispatch to be declined in a database in response to determining that the at least one load is not accepted, or setting a load dispatch to be accepted in the database in response to determining that the at least one load is accepted.

Of course, the present is simply a summary, and not a complete description of the invention.

### BRIEF DESCRIPTION OF THE DRAWINGS

Various aspects of the invention and its embodiment are better understood by referring to the following detailed description. To understand the invention, the detailed description should be read in conjunction with the drawings.

FIG. 1 illustrates a logistics communication system.

FIG. 2 is a flow diagram illustrating operations of the logistics communication system for recommending a driver in a logistics environment.

FIG. 3 is an example flow diagram illustrating an admin-load-dispatch technique.

FIG. 4 is an example flow diagram illustrating a load-dispatch technique.

FIG. 5 is an example flow diagram illustrating a driver-mine-check-in technique.

FIG. 6 is an example flow diagram illustrating a driver-notification technique.

FIG. 7 is an example flow diagram illustrating an on-duty driver monitoring technique.

FIG. 8 is an example flow diagram illustrating an off-duty driver monitoring technique.

FIG. 9 is an example flow diagram illustrating a job progress.

FIG. 10 is an example load-status relationship.

FIG. 11 illustrates an example exodus-database-diagram.

FIG. 12 illustrates an example address-application relationship with a carrier and a driver.

FIG. 13 illustrates an example job-application relationship among a job, a job status, a job carrier and a customer.

FIG. 14 illustrates an example load application relationship among the job, a route, the carrier and the driver.

FIG. 15 illustrates an example notification application relationship among the driver, the load and a notification status.

FIG. 16 illustrates an example route application relationship among a route, a mine, a well and a location.

FIG. 17 illustrates an example shift application relationship between a shift time and the driver.

FIG. 18 illustrates an example user application relationship among a customer, a customer admin, a unit, a unit status, the driver, a profile, the carrier and a carrier admin.

FIG. 19 is an example flow diagram illustrating a job auto dispatch feature progress.

### DESCRIPTION OF AN EXEMPLARY PREFERRED EMBODIMENT

### Interpretation Considerations

While reading this section (Description of An Exemplary Preferred Embodiment, which describes the exemplary embodiment of the best mode of the invention, hereinafter referred to as “exemplary embodiment”), one should consider the exemplary embodiment as the best mode for practicing the invention during filing of the patent in accordance with the inventor's belief. As a person with ordinary skills in the art may recognize substantially equivalent structures or substantially equivalent acts to achieve the same results in the same manner, or in a dissimilar manner, the exemplary embodiment should not be interpreted as limiting the invention to one embodiment.

The discussion of a species (or a specific item) invokes the genus (the class of items) to which the species belongs as well as related species in this genus. Similarly, the recitation of a genus invokes the species known in the art. Furthermore, as technology develops, numerous additional alternatives to achieve an aspect of the invention may arise. Such advances are incorporated within their respective genus and should be recognized as being functionally equivalent or structurally equivalent to the aspect shown or described.

A function or an act should be interpreted as incorporating all modes of performing the function or act, unless otherwise explicitly stated. For instance, sheet drying may be performed through dry or wet heat application, or by using microwaves. Therefore, the use of the word “paper drying” invokes “dry heating” or “wet heating” and all other modes of this word and similar words such as “pressure heating”.

Unless explicitly stated otherwise, conjunctive words (such as “or”, “and”, “including”, or “comprising”) should be interpreted in the inclusive and not the exclusive sense.

As will be understood by those of the ordinary skill in the art, various structures and devices are depicted in the block diagram to not obscure the invention. In the following discussion, acts with similar names are performed in similar manners, unless otherwise stated.

The foregoing discussions and definitions are provided for clarification purposes and are not limiting. Words and phrases are to be accorded their ordinary, plain meaning, unless indicated otherwise.

### Description of the Drawings, a Preferred Embodiment

The present invention provides logistics communication systems and methods using a set of algorithms which recommends a driver in a logistics environment in a simple and cost-effective way. The present invention is a data enrichment platform which combines many data sets relevant to planning and recommending the driver in the logistics environment. Advantageously, the present invention provides an advanced driver recommendation system based on various information to enhance the customer experience in the logistics environment. Particular advantages of the invention are found in “last-mile” deliveries (generally understood as the final stage of logistics where items move from a warehouse, depot, hub, distribution center, or other storage facility to a final destination) in the oil and gas industry, and in particular with the delivery of oil and gas drilling supplies such as fracking solution, sand, and other industrial consumables.

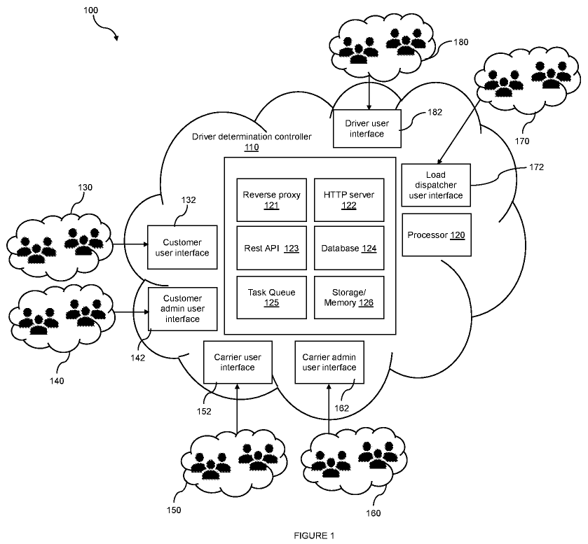

Accordingly, FIG. 1 illustrates a logistics communication (or communications) system 100. The logistics communication system 100 is, but not limited to, a cloud-based system. The logistics communication system 100 may comprise subsystems, hardware, distributed computing, software, entity interfaces, and user interfaces which enable and deliver the services/functions of the present invention as described herein.

The logistics communication system 100 generally comprises a driver determination controller 110 that further comprises a processor 120, a reverse proxy 121, a Hypertext Transfer Protocol (HTTP) server 122, a rest application programming interface (API) 123, a database 124, a task queue 125, a storage/memory 126, and a plurality of user interfaces like a customer user interface 132, a customer amin user interface 142, a carrier user interface 152, a carrier admin user interface 162, a load dispatcher user interface 172 and a driver user interface 182 for example, for a plurality of users like customer 130, customer admin 140, carrier 150, carrier admin 160, load dispatcher 170, driver 180 respectively. Each of the plurality of users 130, 140, 150, 160, 170, 180 can access the driver determination controller 110 using their respective user interfaces 132, 142, 152, 162, 172, 182, via respective user terminals (not shown). The user terminals can be a laptop, a notebook, a desktop computer, a vehicle to everything (V2X) device, a smartphone, a tablet, an internet of things (IoT) device, a television with communication facility, an immersive device, a virtual reality device, a pager or any other computing device including similar hardened and field-specific devices, for example. The driver determination controller 110 acts as a core element of the logistics communication system 100. The driver determination controller 110 is configured to be accessed by the plurality of users 130, 140, 150, 160, 170 in the logistics communication system 100 for determining the best fit driver.

The driver determination controller 110 also acts as a forecasting tool for determining the driver's availability and a number of drivers in surrounding locations for their needs in the logistics activity. Advantageously, the driver determination controller 110 saves time as compared to existing driver finding platforms and techniques.

The driver determination controller 110 receives a query from a user to find the driver from a plurality of drivers. The user can be, for example, but not limited to the customer 130, the carrier 150 and the load dispatcher 170. The customer can be, for example, but not limited to a supplier, a manufacturer, a consumer products group, a logistics partner, a retailer or the like. Based on the query, the driver determination controller 110 determines one or more event(s) and one or more parameter(s) to select the driver from the plurality of drivers. The one or more event(s) can be, for example, but not limited to a ready for dispatch event, an accepted event, a loaded event, a delivered event, a paused event, a delayed event and a cancelled event. The ready for dispatch event refers to a process of releasing or sending out a shipment/load for delivery. The ready for dispatch event includes coordinating various activities for a transportation plan. The accepted event refers to the driver 180 having accepted the booking activity from the customer 130. The loaded event refers to the driver 180 waiting to start the vehicle, meanwhile the carrier admin 160 loads the goods/service items in the vehicle. The delivered event refers to the driver 180 delivering the goods/items to a predefined location. The paused event refers to the driver 180 not accepting any query due to his/her personal work load or any other circumstances. The delayed event refers to the driver 180 delivering the goods/items to the predefined location, but the delivery time is beyond the scheduled time due to various reasons (e.g., traffic, road conditions, weather or the like). The cancelled event refers to the driver 180 not accepting the booking activity from the customer 130 or cancelled the booking. The one or more parameter(s) can be, for example, but not limited to a driver profile, owner operator (for example, a truck driver that owns and operates his/her own vehicle), a carrier identifier, a unit identifier, on-duty time, off-duty time, name of the driver, a driver license number, a tax identifier number, date of birth of the driver, locked-out time, locking time, and shift time.

In an embodiment of the present invention, the driver determination controller 110 selects the driver from the plurality of drivers by changing a load state to dispatched, filtering the at least one driver from the plurality of drivers by the carrier 150, filtering an off-duty driver from the plurality of drivers, filtering a busy driver from the plurality of drivers, filtering a notified driver from the plurality of drivers, and sorting the driver from the plurality of drivers based on waiting time for load. In an example, the off-duty driver is filtered by obtaining information about the plurality of drivers, identifying the off-duty driver from the plurality of drivers by counting hours of off-duty over a period of time for each shift, determining if the hours of off duty are less than a predefined time, and filtering the off-duty driver based on the determination.

In another embodiment of the present invention, the driver determination controller 110 selects the driver from the plurality of drivers by determining if one or more load(s) is dispatched, determining if the driver is not available, selecting the carrier 150 for dispatching the one or more load(s) using a load job identifier, selecting the driver from the plurality of drivers, sorting the driver from the plurality of drivers based on a last load accepted time, and notifying the sorted driver from the plurality of drivers, where location of the sorted driver is close/nearby to the location of the user. The selected driver may be an on-duty driver. The driver is selected based on a load status completed event and a load status cancelled event.

In an alternative embodiment of the present invention, the driver determination controller 110 selects the driver from the plurality of drivers by selecting one or more carrier(s) for dispatching the load using a load job identifier, determining if the driver is new, and notifying the new driver for dispatching the load by prioritizing the new driver from the plurality of drivers.

In an alternative embodiment of the present invention, the driver determination controller 110 selects the driver from the plurality of drivers by checking into a mine list, obtaining a latitude and a longitude using a World Geodetic System (WGS) upon checking into the mine list, determining if the load is accepted, determining that the driver is close to the user, and changing a load state to loaded or delivered.

In an alternative embodiment of the present invention, the driver determination controller 110 selects the driver from the plurality of drivers by receiving a request notification for one or more load(s), determining if the one or more load(s) is accepted, and setting a load dispatch to be accepted in the database 124 in response to determining if the one or more load(s) is accepted. The load dispatch to be accepted is set in the database 124 by determining if the driver is available, changing the load state to be accepted, and setting the load dispatch to be accepted in the database 124.

In an alternative embodiment of the present invention, the driver determination controller 110 selects the driver from the plurality of drivers by receiving the request notification for one or more load(s), determining that the one or more load(s) is declined, and setting the load dispatch to be declined in a database 124 in response to determining that the at least one load is not accepted.

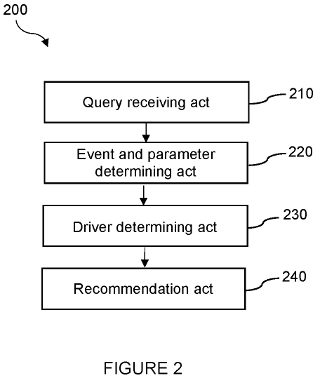

The aforementioned selection processes of the driver from the plurality of drivers are explained in detail below in conjunction with FIG. 2 to FIG. 10 and FIG. 19.

The driver determination controller 110 recommends the determined/selected driver from the plurality of drivers to the user. Further, the driver determination controller 110 measures performance of the driver in terms of score. In an example scenario, the driver determination controller 110 measures performance of the driver based on the working time, punctuality, and driver behaviour. The driver determination controller 110 automatically measures pass or fail on the performance of the driver during working hours. In an embodiment of the present invention, the driver determination controller 110 may utilize feedbacks for performance measurement.

Now referring to the plurality of user interfaces and the plurality of users. The customer 130 and the customer admin 140 through the customer user interface 132 and the customer admin user interface 142 respectively, operate, upgrade, maintain and manage the driver determination controller 110. The customer 130 and the customer admin 140 can be, for example, but not limited to a logistics partner, a product manufacturer and a product supplier. Similarly, the at least one carrier 150, the carrier admin 160 and the load dispatcher 170 through the carrier user interface 152, the carrier admin user interface 162, and the load dispatcher user interface 172 respectively interact with the driver determination controller 110 for driver booking/selection. Similarly, the driver 180 through the driver user interface 182 interacts with the driver determination controller 110 to accept/decline the driver booking.

Further, the logistics communication system 100 includes the processor 120 having one or more processors, which may be configured to perform all the processing functionalities of the present invention. The one or more processors may be a general-purpose processor, such as a central processing unit (CPU), an application processor (AP), or the like, a graphics-only processing unit such as a graphics processing unit (GPU), a visual processing unit (VPU), and/or an AI-dedicated processor such as a neural processing unit (NPU), for example. At least one of aforesaid units/blocks may perform their functions by using the processor 120. A function associated with the driver determination controller 110 may be performed by utilizing the information stored in the database 124 and the storage/memory 126 like a non-volatile memory, volatile memory, for example and by utilizing the processor 120. The database 124 can be, for example, but not limited to a relational database and a non-relational database. The relational database and the non-relational database can be, for example, but not limited to a MySQL, SQL Server database (DB), MariaDB, MongoDB, Oracle Database, PostgreSQL, Informix, Sybase, and IBM Db2. The database 124 can also be, for example, but not limited to a hierarchical database system, a network database system, an object-oriented database system, an operational database, a graph database, an Amazon Web Services (AWS) Databases, and a cloud database.

The processor 120 communicates with the reverse proxy 121, the HTTP server 122, the rest API 123, and the task queue 125. The reverse proxy 121 is a server/application that sits in front of the HTTP server 122, intercepting requests from the users (e.g., customer 130, customer admin 140 or the like) through the rest API 123, where the rest API 123 may run on the user terminals. The task queue 125 keeps the one or more query(ies) in order.

Further, the logistics communication system 100 may include a communication block (not shown) that enables and simplifies communication between all of participants of the logistics communication system 100 by bringing an instant messaging layer as a central mode of communication between each other. When demand changes, the right participants can quickly swarm that issue together through a simple text message. In this way, the communication block enables true just in time pickup and delivery unlike existing platforms and brings transparency in the logistics communication system 100.

In an embodiment of the present invention, the logistics communication system 100 may have an AI (Artificial Intelligence) unit (not shown) that implements a machine learning method called deep learning. The machine learning method enables the logistics communication system 100 to automatically learn and improve from experience, over a period of time, without being explicitly programmed. The deep learning method uses a neural network capable of learning in an unsupervised manner from data that is unstructured or unlabeled. Deep learning is a method of machine learning that employs multiple layers of neural networks that enable the platform of the present invention to teach itself through inference and pattern recognition, rather than development of procedural code or explicitly coded software algorithms (however, machine learning is augmented and enhanced with software algorithms). The neural networks are modeled according to the neuronal structure of a mammal's cerebral cortex, where neurons are represented as nodes and synapses are represented as uniquely weighted paths or “tolled roads” between the nodes. The nodes are then organized into layers to comprise a network. Additionally, the neural networks are organized in a layered fashion that includes an input layer, intermediate or hidden layers, and an output layer.

The neural networks enhance their learning capability by varying the uniquely weighted paths based on received input. The successive layers within the neural network incorporate the learning capability by modifying their weighted coefficients based on their received input patterns. From this foundation, one can see that the training of the neural networks is very similar to how we teach children to recognize an object. The neural network is repetitively trained from a base data set, where results from the output layer (or, simply “output”) are successively compared to the correct classification.

Alternatively, any machine learning paradigm instead of neural networks can be used in the training and learning process. The AI unit supports several different scoring algorithms oriented on the recommending driver.

Although FIG. 1 shows various components of the logistics communication system 100 but it is to be understood that other embodiments are not limited thereon. The logistics communication system 100 may include less or more number of components. Further, the labels or names of the components are used only for illustration purposes and do not limit the scope of the present invention. One or more components can be combined together to perform same or substantially similar function in the logistics communication system 100.

FIG. 2 is a flow diagram (of logistics communication method 200) illustrating operations of the logistics communication system 100 for recommending the driver 180 in the logistics environment. Referring to FIG. 2, in a query receiving act 210, the driver determination controller 110 receives the query from the user to find the driver from the plurality of drivers. In an event and parameter determining act 220, the driver determination controller 110 determines the one or more event(s) and the one or more parameter(s) to select the driver from the plurality of drivers based on the query.

In a driver determining act 230, the driver determination controller 110 determines the driver from the plurality of drivers based on the one or more event(s) and the one or more parameter(s). In a recommendation act 240, the driver determination controller 110 recommends the determined driver from the plurality of drivers.

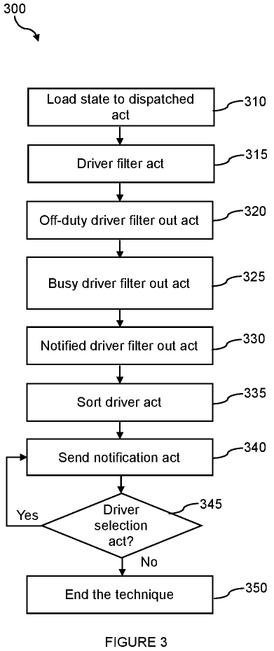

FIG. 3 is an example flow diagram illustrating an admin-load-dispatch(ed) technique 300. In order to find a driver and ship a product, in a load state to dispatched act 310, the driver determination controller 110 loads the product/shipment to be dispatched for a delivery place/location. In a driver filter act 315, the driver determination controller 110 filters the driver by the carrier 150. For example, if the shipment is heavy/bulky, then the driver determination controller 110 selects the driver based on carrier (vehicle) size. In an example, if the luggage is heavy or more in numbers, the driver determination controller 110 will allow selecting SUV car instead of normal car. In an off-duty driver filter out act 320, the driver determination controller 110 filters out the off-duty driver.

Next, in a busy driver filter out act 325, the driver determination controller 110 filters out the busy driver (for example, busy driver can be a driver who is currently serving). By implementing the aforementioned filters, the remaining drivers are notified about the booking and the notified driver(s) are filtered out in a notified driver filter out act 330 by the driver determination controller 110.

In a sort driver act 335, the driver determination controller 110 sorts the notified drivers by the time waiting (or waiting time) for the load pick up. The notified driver having a lesser waiting time may be selected. In a send notification act 340, the driver determination controller 110 sends the notification to the selected driver. In a driver selection act 345, the driver determination controller 110 determines whether there was a success in finding the driver or not. If the driver selection is successful, then technique 300 ends at 350, else the technique 300 moves back to the send notification act 340 until the driver selection is successful.

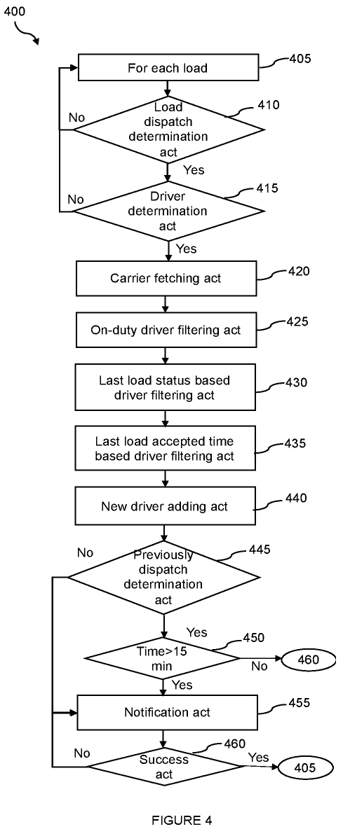

FIG. 4 is an example flow diagram illustrating a load-dispatch (ed) technique 400. The technique 400 is performed for each load 405. In a load dispatch determination act 410, the driver determination controller 110 determines if the load is ready for dispatch or not. If the load is not ready for dispatch then, the operation moves to act 405 to initiate the technique 400 to check if a new load is ready for dispatch. If the load is ready for dispatch then, in a driver determination act 415, the driver determination controller 110 determines whether the driver is available or not to ship the load. Upon determining that the driver is not available, the operation moves to act 405. If the driver is available then, in a carrier fetching act 420, the driver determination controller 110 fetches the carrier 150 by the load job identifier. Next, in an on-duty driver filtering act 425, the driver determination controller 110 filters the drivers who are on-duty. Next, in a last load status-based driver filtering act 430, the driver determination controller 110 filters the drivers by the last load status. In an example, the last load status may be “cancelled”. In another example, the last load status may be “completed”.

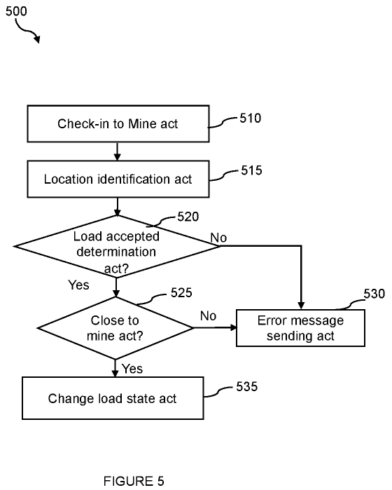

Next, in a last load accepted time based driver filtering act 435, the driver determination controller 110 sorts the drivers by the last load accepted time. For example, the driver determination controller 110 selects the driver 180 who accepted the previous booking query (ies) soon (or responded in less waiting time). This can be determined based on customer feedback(s), for example. In a new driver adding act 440, the driver determination controller 110 adds new drivers (who have served very less) to a list. Next, in a previously dispatch determination act 445, the driver determination controller 110 determines if the new driver(s) met the expectation of the customer(s) during the previous dispatch or not. If the new driver has not met the expectation previously, the technique 400 moves to and stops at act 460. If the new driver has met the expectation previously, then in act 450, the driver determination controller 110 determines if a waiting time is less than a predefined time (for example 15 min) or not. If the waiting time is less than the predefined time, then the technique 400 moves to a success act 460 depicting that a suitable driver has been found. If the waiting time is greater than the predefined time, then the technique 400 moves to a notification act 455, where the driver determination controller 110 notifies the next driver in queue. Then, the technique 400 moves to the success act 460 depicting that a suitable driver has been found. In case of no success, the technique 400 moves to the notification act 455 and forms a loop until a suitable driver has been found. FIG. 5 is an example flow diagram illustrating a driver-mine-check-in technique 500. In order to find a driver, in a check-in to mine act 510, the driver determination controller 110 checks in a mine list for locations of the drivers (e.g., preferred drivers). The mine list may be predefined or configured by the user. Next, in a location identification act 515, the driver determination controller 110 determines the latitude and/or longitude (Lat/Lon) of the driver(s) using the World Geodetic System (WGS) (for example WGS84).

Next, in a load accepted determination act 520, the driver determination controller 110 determines if the load is accepted or not by the driver. If the load is accepted then, the technique 500 moves to a close to mine act 525, where the driver determination controller 110 determines if the driver is close to the customer location or not. Upon determining that the driver is close to the customer then, in a change load state act 535, the driver determination controller 110 changes the load state of the product/shipment to loaded or delivered. If the load is not accepted and/or if the driver is not close to the customer, then in an error message sending act 530, the driver determination controller 110 sends an error message to a mobile client informing the non-availability of the preferred driver in the nearby location.

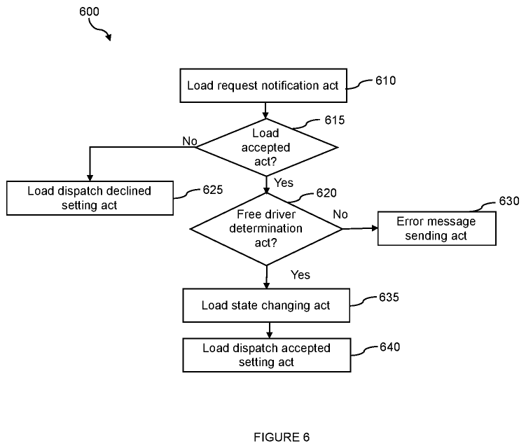

FIG. 6 is an example flow diagram illustrating a driver-notification technique 600. In a load request notification act 610, the driver determination controller 110 receives a load request notification sent by the user, for example customer.

Next, in a load accepted act 615, the driver determination controller 110 determines if the load is accepted or not by the logistics communication system 100. Upon determining that the load is not accepted, in a load dispatch declined setting act 625, the driver determination controller 110 sets the load dispatch status as “declined”, which means that the logistics communication system 100 is not accepting (i.e., declining) the booking activity from the customer 130. It may happen due to various reasons such as unavailability of driver, traffic, weather conditions, payment issues, road condition, customer behaviour's feedback, for example. Upon determining that the load is accepted, in a free driver determination act 620, the driver determination controller 110 determines whether the driver is free or not. Upon determining that the driver is not free, in an error message sending act 630, the driver determination controller 110 sends the error message (like no driver found, for example) to the user terminal of the user, like customer.

Upon determining that the driver is free, in a load state changing act 635, the driver determination controller 110 changes the load state to accepted. For example, if the driver accepts the load from the customer, then the load state is changed to accepted state. Next, in a load dispatch accepted setting act 640, the driver determination controller 110 sets the load dispatch status as “accepted” and the same is notified to the customer.

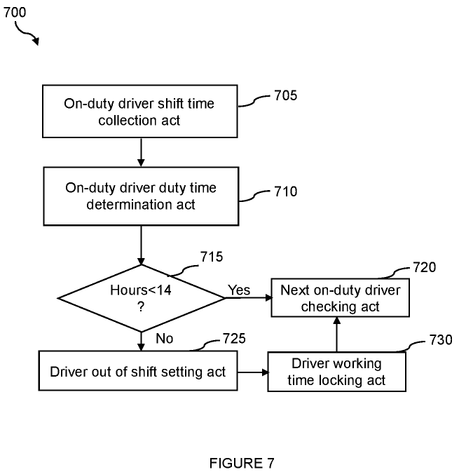

FIG. 7 is an example flow diagram illustrating an on-duty driver monitoring technique 700. In an on-duty driver shift time collection act 705, the driver determination controller 110 collects all shifts' time for each driver. In an example, the shifts' time is less than or equal to 48 hours. In an on-duty driver duty time determination act 710, the driver determination controller 110 counts the working hours of the driver for each shift. In act 715, the driver determination controller 110 determines whether the working hour is less than a predefined time (for example 14 hours) or not. Upon determining that working hour is less than the predefined time, in a next on-duty driver checking act 720, the driver determination controller 110 checks the next driver's working hours. Upon determining that the working hour is more than the predefined time, in the driver out of shift setting act 725, the driver determination controller 110 sets the status of the driver as “out of shift”. For example, if as per the system 100, a driver needs to work only for 14 hours, and if this period is completed/utilized by the driver, the driver determination controller 110 automatically sets the driver status as “out of shift”. In a driver working time locking act 730, the driver determination controller 110 locks out the driver who is “out of shift” and then moves to the next on-duty driver checking act 720.

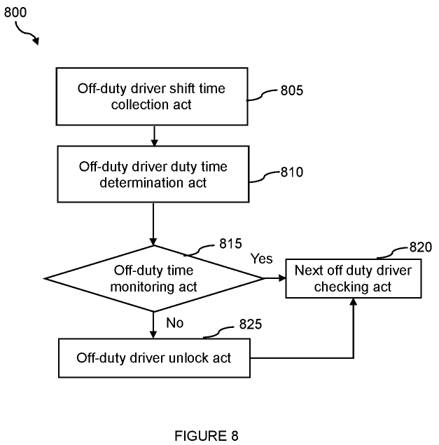

FIG. 8 is an example flow diagram illustrating an off-duty driver monitoring technique 800. In an off-duty driver shift time collection act 805, the driver determination controller 110 collects all shifts' time for each off-duty driver for a specific period. Next, in an off-duty driver duty time determination act 810, the driver determination controller 110 counts the working hours of the off-duty driver for each shift for a specific period. In an off-duty time monitoring act 815, the driver determination controller 110 determines if the off-duty hours are less than a predefined level (For example, 10 hours). In a next off duty driver checking act 820, the driver determination controller 110 checks the next driver's off-duty time in response to the off-duty hours being less than the predefined level. Upon determining that the off-duty hours are not less than the predefined level, in an off-duty driver unlock act 825, the driver determination controller 110 unlocks the driver so that he/she can accept the bookings.

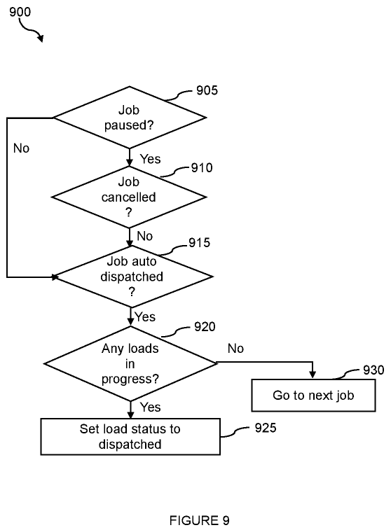

FIG. 9 is an example flow diagram illustrating a job progress 900. Herein, a job is any activity (like shipment, load dispatch, delivery, for example) performed by the driver based on the customer's query. Initially, the driver determination controller 110 determines if a job is paused at 905. If yes, the driver determination controller 110 determines, at 910, if the job is cancelled. If the job is neither paused nor cancelled, the driver determination controller 110 allows auto-dispatch of the job at 915. Next, the driver determination controller 110 determined if any load(s) is in progress. If yes, the driver determination controller 110 sets the load status to “dispatched” at 925 and processes the load. If no, the driver determination controller 110 picks up the next job at 930.

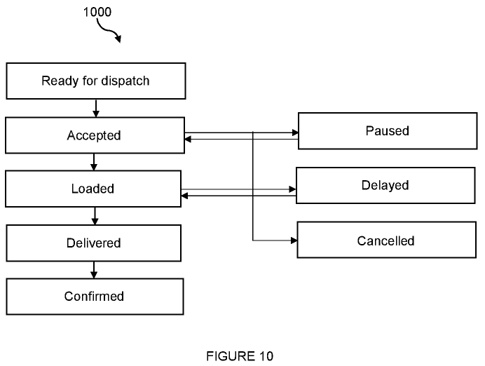

FIG. 10 is an example load-status relationship 1000, where various load-status are shown. The load-status can be “ready for dispatch”, “accepted”, “loaded”, “delivered”, “confirmed”, “paused”, “delayed” and “cancelled”, which are already explained above in conjunction with FIG. 1 in the form of events.

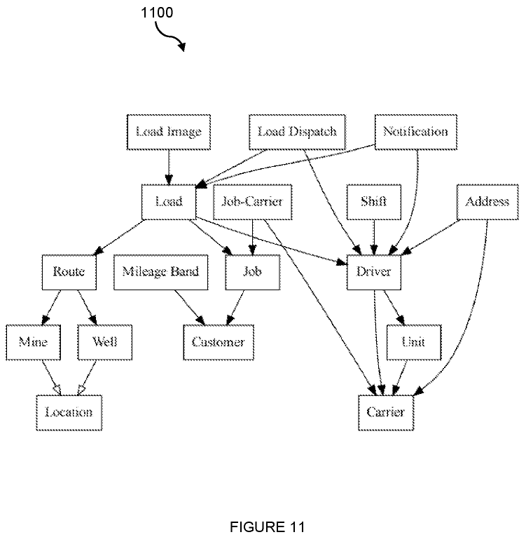

FIG. 11 illustrates an example exodus-database-diagram 1100. The exodus-database-diagram 1100 shows a relationship between all major components (e.g., load, carrier, customer, etc.) used in the logistics communication system 100. In an example, the driver is selected based on the load, the shift time (or work time), the address for the service. The driver is associated with the carrier 150. The location is determined based on the mine, the well and the route.

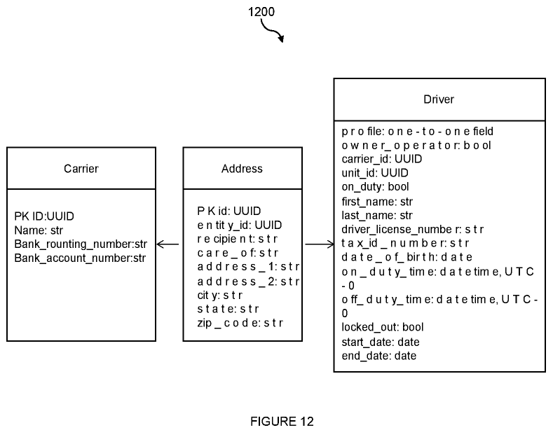

FIG. 12 illustrates an example address-application relationship 1200 with the carrier 150 and the driver 180. An address field includes following data (e.g., pick up identifier (PK ID), entity identifier (ID), recipient, care of information, first address line, second address line, city, state, and zip code, for example). A carrier field includes following data (e.g., PK ID, Name, bank routing number, bank account number, or the like) and a driver field includes following information (e.g., profile, owner operator, carrier ID, unit ID, on-duty time, first name, last name, driver license number, taxi ID number, date of birth, on-duty time, off-duty time, locked out time, start date and end date).

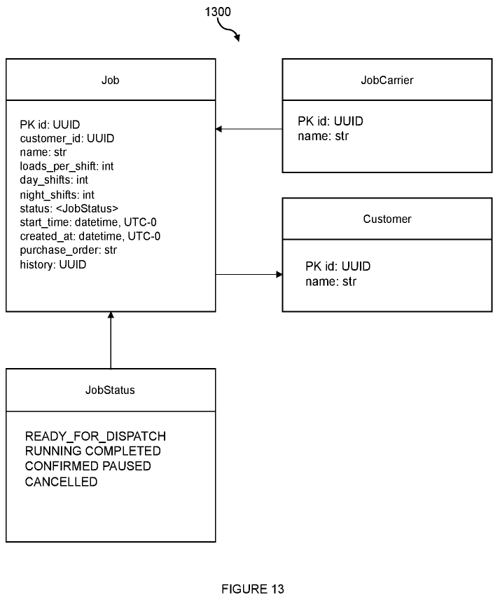

FIG. 13 illustrates an example job-application relationship 1300 among the job, the job status, the job carrier and the customer. A job field includes, for example, PK id, customer id, name, loads per shift, day shifts, night shifts, status, start time, job created time, purchase order, and history. A job carrier field includes, for example, PK ID and name. A customer field includes, for example, PK id and name. A job status field includes status like ready for dispatch, running, completed, confirmed, paused, and cancelled, for example.

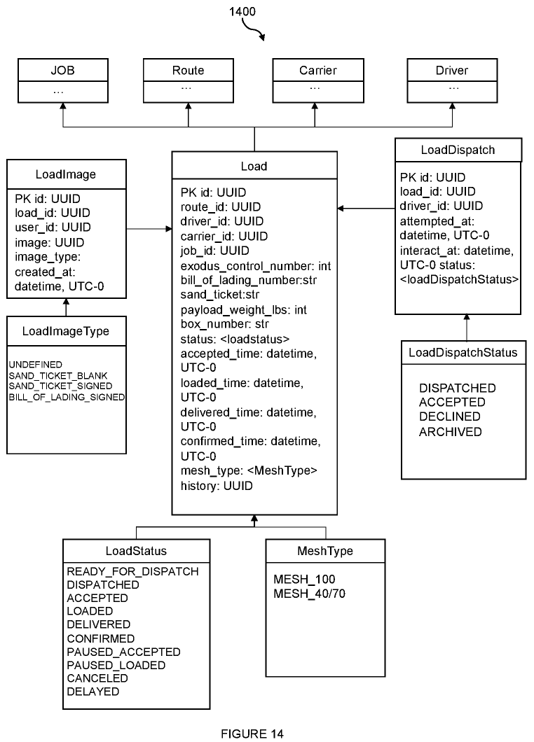

FIG. 14 illustrates an example load application relationship 1400 among the job, the route, the carrier and the driver. The load application relationship 1400 is determined based on one or more parameter(s) (e.g., Load Image, Load Image Type, Load, Load Dispatch, Load Dispatch Status, Mesh Type and Load Status) as depicted in FIG. 14.

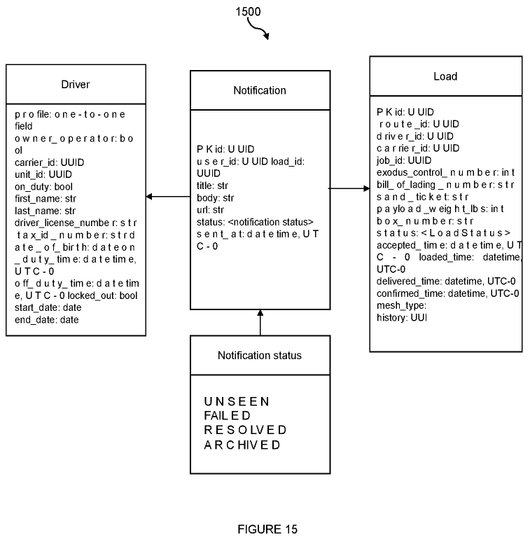

FIG. 15 illustrates an example notification application relationship 1500 among the driver, the load and the notification status. The notification status field includes, for example, but not limited to unseen status, failed status, resolved status, and archived status. The driver field includes, for example, but not limited to profile, owner operator, carrier id, unit id, on-duty, first name, last name, driver license number, taxi id number, date of birth, on-duty time, off-duty time, locked out time, start date and end date. The load field includes, for example, but not limited to PK ID, route ID, driver ID, carrier ID, job ID, exodus control number, bill of lading number, sand ticket, payload weight, box number, status, accepted time, loaded time, delivered time, confirmed time, mesh type, and history.

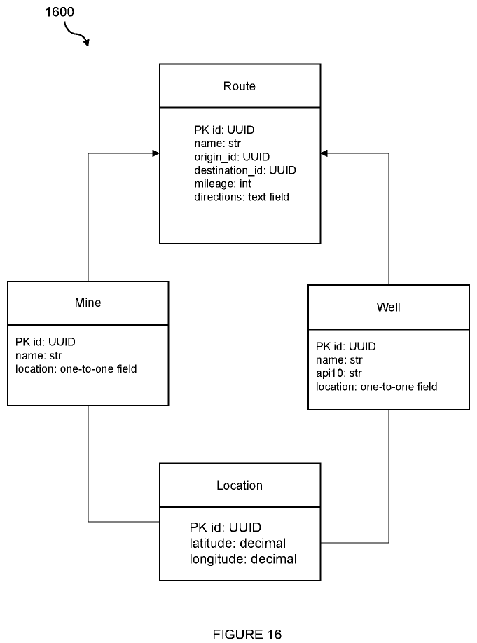

FIG. 16 illustrates an example route application relationship 1600 among the route, the mine, the well and the location. The route (or route field) includes PK id, name, origin id, destination id, mileage and directions. The mine (or mine field) includes PK id, name, and location. The well (or well field) includes PK id, name, and location, for example. The location (or location field) includes PK id, latitude, and longitude.

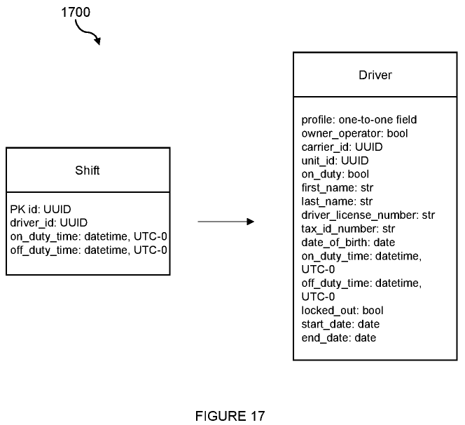

FIG. 17 illustrates an example shift application relationship 1700 between the shift time (or shift time field) and the driver field. The driver field includes following information (e.g., profile, owner operator, carrier ID, unit ID, on-duty, first name, last name, driver license number, taxi ID number, date of birth, on-duty time, off-duty time, locked out time, start date and end date. The shift time field includes PK id, driver id, on duty time, and off-duty time.

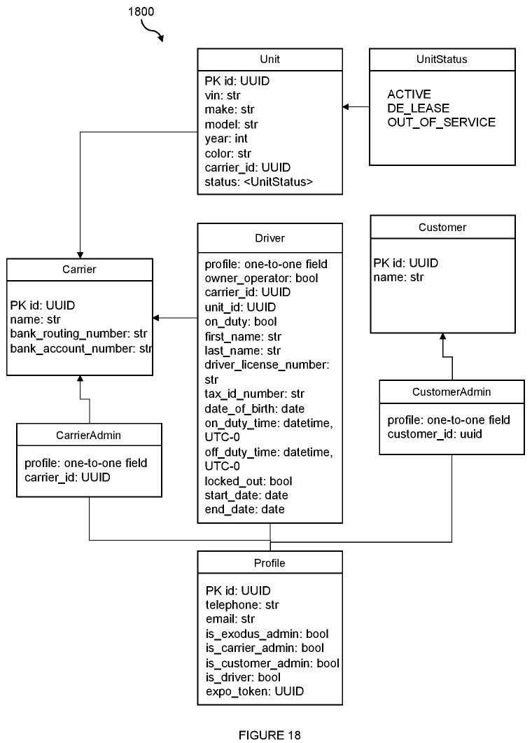

FIG. 18 illustrates an example user application relationship 1800 among the customer, the customer admin, the unit, the unit status, the driver, the profile, the carrier and the carrier admin. The driver field includes following information (e.g., profile, owner operator, carrier ID, unit ID, on-duty, first name, last name, driver license number, taxi ID number, date of birth, on-duty time, off-duty time, locked out time, start date and end date). The carrier field includes following data (e.g., PK ID, Name, bank routing number, bank account number, or the like). The carrier admin field includes profile and carrier ID. The customer field includes a PK ID and name. The customer admin field includes profile and customer ID. The unit field includes PK ID, vin (vehicle identification number), model, year, color, carrier and status. The unit status field includes an active status, a lease status, and an out of service status. The profile field includes PK ID, telephone, mobile phone, email ID, and other admin details.

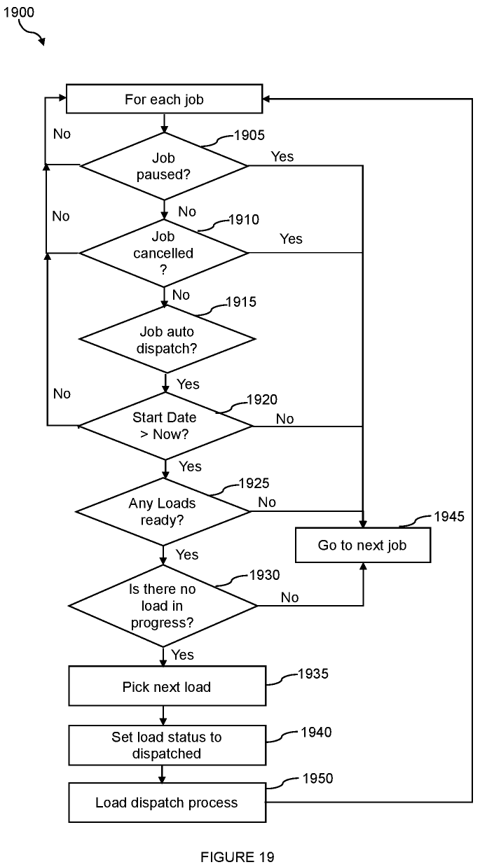

FIG. 19 is an example flow diagram illustrating a job auto dispatch feature progress 1900. Herein, the job is any activity (like shipment, load dispatch, delivery, for example) performed by the driver based on the customer's query. The job auto dispatch feature progress is an iterative or a loop-based process and is checked for each job. Initially, for each job, the driver determination controller 110 determines if the job is paused at 1905. If no, the driver determination controller 110 determines, at 1910, if the job is cancelled. If the job is neither paused nor cancelled, the driver determination controller 110 checks if the job is marked for auto-dispatch or not at 1915. If the job is paused or cancelled, the driver determination controller 110 moves to the next job at 1945.

If the job is marked as “auto dispatch” at 1915, then the driver determination controller 110 determines a job start date at 1920. If the job start date is in the past or relative to now (near real-time), then the driver determination controller 110 moves forward, and checks all the loads at 1925. If the job start date is in the future, the driver determination controller 110 moves to the next job at 1945.

At 1925, the driver determination controller 110 particularly determines if any load(s) is in ready stage. If any load(s) is not in the ready stage, then the driver determination controller 110 moves to the next job at 1945.

If the load is in the ready stage, then the driver determination controller 110 determines if any load(s) is in progress at 1930. If yes, the driver determination controller 110 picks the next load at 1935 and sets the load status to “dispatched” at 1940 and processes the load at 1950. The load dispatch process is a separate background process that takes the load and searches for the suitable driver to grab the load and get it delivered to the suitable destination. If any load(s) is not in progress, the driver determination controller 110 picks up the next job at 1945.

The aforementioned fields shown in FIGS. 11 to 18 are example fields to be used in the logistics communication system 100. The logistics communication system 100 may use more or less fields as per implementation. It may be noted that FIGS. 1 and 2 are to be understood in conjunction with FIG. 3 to FIG. 19.

The various actions, acts, blocks, steps, or the like in the flow diagrams may be performed in the order presented, in a different order or simultaneously. Further, in some embodiments, some of the actions, acts, blocks, steps, or the like may be omitted, added, modified, skipped, or the like without departing from the scope of the present invention.

Unless otherwise defined, all technical and scientific terms used herein have the same meaning as commonly understood by one of ordinary skill in the art to which this invention belongs. Although methods and materials similar to or equivalent to those described herein can be used in the practice or testing of equivalent systems and methods, suitable systems and methods and are described above.

Although the invention has been described and illustrated with specific illustrative embodiments, it is not intended that the invention be limited to those illustrative embodiments. Those skilled in the art will recognize that variations and modifications can be made without departing from the spirit of the invention. Therefore, it is intended to include within the invention, all such variations and departures that fall within the scope of the appended claims and equivalents thereof.

What is claimed is:

1. A method for recommending a driver in a logistics environment, the method comprising:
receiving, by a logistics communication system, at least one query from a user to find a driver from a plurality of drivers, wherein the user comprises at least one of a customer, a carrier and a load dispatcher;
determining, by the logistics communication system, at least one event and at least one parameter to select the driver from the plurality of drivers based on the at least one query;
determining, by the logistics communication system, the driver from the plurality of drivers based on the at least one event and the at least one parameter; and
recommending, by the logistics communication system, the determined driver from the plurality of drivers to the user.

2. The method of claim 1 wherein determining, by the logistics communication system, the driver from the plurality of drivers comprises:
changing, by the logistics communication system, a load state to dispatched;
filtering, by the logistics communication system, the at least one driver from the plurality of drivers by the carrier;
filtering, by the logistics communication system, an off-duty driver from the plurality of drivers;
filtering, by the logistics communication system, a busy driver from the plurality of drivers;
filtering, by the logistics communication system, a notified driver from the plurality of drivers; and
sorting, by the logistics communication system, the driver from the plurality of drivers based on waiting time for load.

3. The method of claim 2 wherein filtering, by the logistics communication system, the off-duty driver comprises:
obtaining, by the logistics communication system, information about the plurality of drivers;
identifying, by the logistics communication system, the off-duty driver from the plurality of drivers by counting hours of off duty over a period of time for each shift;
determining, by the logistics communication system, that the hours of off duty is less than a predefined time; and
filtering, by the logistics communication system, the off-duty driver based on the determination.

4. The method of claim 1 wherein determining, by the logistics communication system, the driver from the plurality of drivers comprises:
determining, by the logistics communication system, that at least one load is dispatched;
determining, by the logistics communication system, that the at least one driver is not available;
selecting, by the logistics communication system, at least one carrier for dispatching the at least one load using a load job identifier;
selecting, by the logistics communication system, the at least one driver from the plurality of drivers, wherein the at least one selected driver is on-duty, wherein the at least one driver is selected based on a load status completed event and a load status cancelled event;
sorting, by the logistics communication system, the at least one driver from the plurality of drivers based on a last load accepted time; and
notifying, by the logistics communication system, at least one sorted driver from the plurality of drivers, wherein a location of the at least one sorted driver is closed to a location of the user.

5. The method of claim 1 wherein determining, by the logistics communication system, the driver from the plurality of drivers comprises:
selecting, by the logistics communication system, at least one carrier for dispatching the at least one load using a load job identifier;
determining, by the logistics communication system, that the driver is new; and
notifying, by the logistics communication system, the new driver for dispatching the at least one load by prioritizing the new driver from the plurality of drivers.

6. The method of claim 1 wherein determining, by the logistics communication system, the driver from the plurality of drivers comprises:
checking in, by the logistics communication system, a mine list;
obtaining, by the logistics communication system, a latitude and a longitude using a World Geodetic System (WGS) upon checking in the mine list;
determining, by the logistics communication system, that the load is accepted;
determining, by the logistics communication system, that the driver is close to the user; and
changing, by the logistics communication system, a load state to loaded or delivered.

7. The method of claim 1 wherein determining, by the logistics communication system, the driver from the plurality of drivers comprises:
receiving, by the logistics communication system, a request notification for at least one load;
determining, by the logistics communication system, whether the at least one load is accepted; and
performing, by the logistics communication system, one of:
setting a load dispatch to be declined in a database in response to determining that the at least one load is not accepted; or
setting a load dispatch to be accepted in the database in response to determining that the at least one load is accepted.

8. The method of claim 7 wherein setting the load dispatch to be accepted in the database comprises:
determining, by the logistics communication system, the driver is available;
changing, by the logistics communication system, the load state to be accepted; and
setting, by the logistics communication system, the load dispatch to be accepted in the database.

9. The method of claim 1 wherein the at least one event comprises a ready for dispatch event, an accepted event, a loaded event, a delivered event, a paused event, a delayed event and a cancelled event and wherein the at least one parameter comprises a driver profile, owner operator, a carrier identifier, a unit identifier, on-duty time, off-duty time, name of the driver, a driver license number, a tax identifier number, date of birth of the driver, locked-out time, locking time, and shift time.

10. A logistics communication system, comprising:
a processor;
a memory; and
a driver determination controller, coupled with the processor and the memory, configured to:
receive at least one query from a user to find a driver from a plurality of drivers, wherein the user comprises at least one of a customer, a carrier and a load dispatcher;
determine at least one event and at least one parameter to select the driver from the plurality of drivers based on the at least one query;
determine the driver from the plurality of drivers based on the at least one event and the at least one parameter; and
recommend the determined driver from the plurality of drivers.

11. The logistics communication system of claim 10 wherein determine the driver from the plurality of drivers comprises:
change a load state to dispatched;
filter the at least one driver from the plurality of drivers by the carrier;
filter an off-duty driver from the plurality of drivers;
filter a busy driver from the plurality of drivers;
filter a notified driver from the plurality of drivers; and
sort the driver from the plurality of drivers based on waiting time for load.

12. The logistics communication system of claim 11 wherein filter the off-duty driver comprises:
obtain information about the plurality of drivers;
identify the off-duty driver from the plurality of drivers by counting hours of off duty over a period of time for each shift;
determine that the hours of off duty is less than a predefined time; and
filter the off-duty driver based on the determination.

13. The logistics communication system of claim 10 wherein determine the driver from the plurality of drivers comprises:
determine that at least one load is dispatched;
determine that the at least one driver is not available;
select at least one carrier for dispatching the at least one load using a load job identifier;
select the at least one driver from the plurality of drivers, wherein the at least one selected driver is on-duty, wherein the at least one driver is selected based on a load status completed event and a load status cancelled event;
sort the at least one driver from the plurality of drivers based on a last load accepted time; and
notify at least one sorted driver from the plurality of drivers, wherein a location of the at least one sorted driver is closed to a location of the user.

14. The logistics communication system of claim 10 wherein determine the driver from the plurality of drivers comprises:
select at least one carrier for dispatching the at least one load using a load job identifier;
determine that the driver is new; and
notify the new driver for dispatching the at least one load by prioritizing the new driver from the plurality of drivers.

15. The logistics communication system of claim 10 wherein determine the driver from the plurality of drivers comprises:
check in a mine list;
obtain a latitude and a longitude using a World Geodetic System (WGS) upon checking in the mine list;
determine that the load is accepted;
determine that the driver is close to the user; and
change a load state to loaded or delivered.

16. The logistics communication system of claim 10 wherein determine the driver from the plurality of drivers comprises:
receive a request notification for at least one load;
determine whether the at least one load is accepted; and
perform one of:
set a load dispatch to be declined in a database in response to determining that the at least one load is not accepted; or
set a load dispatch to be accepted in the database in response to determining that the at least one load is accepted.

17. The logistics communication system of claim 16 wherein set the load dispatch to be accepted in the database comprises:
determine that the driver is available;
change the load state to be accepted; and
set the load dispatch to be accepted in the database.
